(19) United States
(12) Patent Application Publication
(10) Pub. No.: US 2007/0214853 A1
(43) Pub. Date: Sep. 20, 2007

(54) Suitcase lock with indicator that can be opened either by setting a combination or by a key

(76) Inventor: Chien-Yung Huang, Banchiao City (TW)

Correspondence Address: PRO-TECHTOR INTERNATIONAL SERVICES, 20775 NORADA CT., SARATOGA, CA, 95070, US

(21) Appl. No.: 11/725,259

(22) Filed: Mar. 19, 2007

(30) Foreign Application Priority Data
Mar. 20, 2006 (TW) 095109480

(51) Int. Cl. E05B 41/00

(52) U.S. Cl. 70/432

(57) ABSTRACT

A suitcase lock with indicator that can be opened either by setting a combination or by a key, in which a key tumbler is additionally fitted to the suitcase lock, and tongues located at a lower portion of a swing plate clamp connect to a slider. A groove at one end of the slider enables a push rod of the key tumbler to be clamped therein, and sloping grooves defined on another end enable the tongues of the swing plate to be displaced therein. In general, dials are used to control cuttings or circular arcs on the sleeves to operate the swing plate and enable hooking or unhooking to a locked object, thereby opening and closing the lock. The suitcase lock of the present invention is characterized in having an indicator for indicating whether the suitcase lock has been opened by a key, wherein the indicator includes an indicator member connected to the housing to enable movement between first and second positions, and the indicator member displays a first surface that is viewable through a window of the housing when in the first position, and displays a second viewable surface when in the second position, wherein the first surface and the second surface differ in appearance from each other.

### BACKGROUND OF THE INVENTION

(a) Field of the Invention

The present invention relates to a suitcase lock with indicator that can be opened either by setting a combination or by a key, and more particularly to a traditional suitcase dial lock in which is installed an additional key tumbler device, which not only enables using dials to open and close the lock, a key can also be used to rotate the key tumbler to force unlocking, thereby providing the present invention with double effectiveness. Moreover, the suitcase lock includes an indicator for indicating whether the suitcase lock has been opened by a key, wherein the indicator includes an indicator member connected to the housing to enable movement between first and second positions.

(b) Description of the Prior Art

Referring to FIG. 11, which shows a conventional suitcase dial lock, wherein a swing plate 200 is installed within a housing 100, and three dials 300 are fitted to the swing plate 200. Sleeves 301 are respectively sleeve joined to the dials 300, and the assembly is sleeve disposed on a shaft 400. Accordingly, such a conventional suitcase dial lock only uses a correct combination of numbers on the dials to enable opening or closing of the lock, and is not provided with a device to force unlocking. Hence, there is a need for improvement in prior art.

### SUMMARY OF THE INVENTION

The present invention relates to a suitcase lock with indicator fitted with a key tumbler and a swing plate, wherein an owner of a suitcase is able to lock or unlock the suitcase using a combination of numbers on dials, and an inspector is able to use a specific key to rotate a key tumbler to open the suitcase for inspection, whereafter the key can be used to rotate to open and restore the key tumbler and lock to its original state. When a combination of numbers on the dials are not those to enable opening the lock (that is, a locked state), then a specific key can be used to rotate the key tumbler and displace a slider, thereby displacing tongues at one end of a swing plate within sloping grooves of the slider, at which time the swing plate is made to tilt in an opposite direction causing a stopper at another end to be no longer hooked to a slot of a locked object, thus enabling the lock to assume an unlocked state.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an exploded perspective view of the present invention.

FIG. 1˜1 is a perspective view depicting an indicator member and indicator of the present invention.

FIG. 1˜2 is a front elevational view of a swing plate of the present invention.

FIG. 1˜3 is a front elevational view of a slider of the present invention.

FIG. 2˜1 is a top sectional view of the present invention in a locked state.

FIG. 2˜2 is a top sectional view of the present invention with the lock, having a locking combination of numbers on dials, opened by a key.

FIG. 2˜3 is a top sectional view of the present invention with the lock, having a locking combination of numbers on dials, in a locked state after being opened by the key.

FIG. 2˜4 is a top sectional view of the present invention with a combination of numbers on the dials being such to enable the lock to be opened.

FIG. 3 is a partial elevational view of the present invention when in an unlocked position, having an unlock combination of numbers on the dials, with a swing plate positioned at a first angle.

FIG. 3˜1 is a partial structural view of the present invention when in an unlocked position, having an unlock combination of numbers on the dials, with the swing plate positioned at the first angle.

FIG. 4 is a schematic view of the present invention when in a locked position, having a locking combination of numbers on the dials, with the swing plate positioned at a second angle.

FIG. 4˜1 is a partial structural view of the present invention when in a locked position, having a locking combination of numbers on the dials, with the swing plate positioned at the second angle.

FIG. 5 is a schematic view of the present invention with the lock, having a locking combination of numbers on the dials, opened by a key, and a third angle of the swing plate is shown.

FIG. 5˜1 is a partial structural view of the present invention with the lock, having a locking combination of numbers on the dials, opened by a key, and the third angle of the swing plate is shown.

FIG. 5˜2 is an enlarged view of the circled section in FIG. 5 of the present invention.

FIG. 6 is another exploded perspective view of the present invention.

FIG. 6˜1 is another perspective view depicting an indicator member and indicator of the present invention.

FIG. 6˜2 is another front elevational view of a swing plate of the present invention.

FIG. 6˜3 is another front elevational view of a slider of the present invention.

FIG. 7˜1 is another top sectional view of the present invention in a locked state.

FIG. 7˜2 is another top sectional view of the present invention with the lock, having a locking combination of numbers on dials, opened by a key.

FIG. 7˜3 is another top sectional view of the present invention with the lock, having a locking combination of numbers on dials, in a locked state after being opened by the key.

FIG. 7˜4 is another top sectional view of the present invention with a combination of numbers on the dials being such to enable the lock to be opened, and indicator having been moved to first surface.

FIG. 8 is another partial elevational view of the present invention when in an unlocked position, having an unlock combination of numbers on the dials, with a swing plate positioned at a first angle.

FIG. 8˜1 is another partial structural view of the present invention when in an unlocked position, having an unlock combination of numbers on the dials, with the swing plate positioned at the first angle.

FIG. 9 is another schematic view of the present invention when in a locked position, having a locking combination of numbers on the dials, with the swing plate positioned at a second angle.

FIG. 9˜1 is another partial structural view of the present invention when in a locked position, having a locking combination of numbers on the dials, with the swing plate positioned at the second angle.

FIG. 10 is another schematic view of the present invention with the lock, having a locking combination of numbers on the dials, opened by a key, and a third angle of the swing plate is shown.

FIG. 10˜1 is another partial structural view of the present invention with the lock, having a locking combination of numbers on the dials, opened by a key, and the third angle of the swing plate is shown.

FIG. 10˜2 is another enlarged view of the circled section in FIG. 5 of the present invention.

FIG. 11 is a top sectional view of a prior art suitcase lock.

### DETAILED DESCRIPTION OF THE PREFERRED EMBODIMENTS

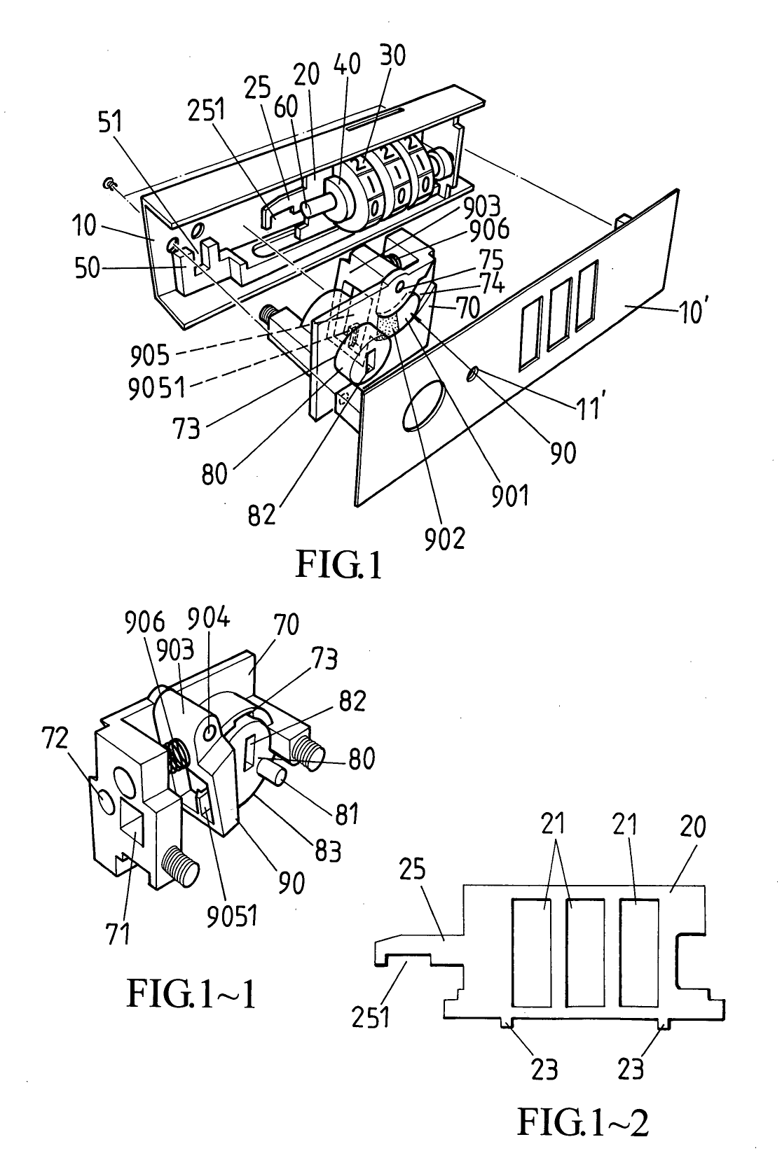

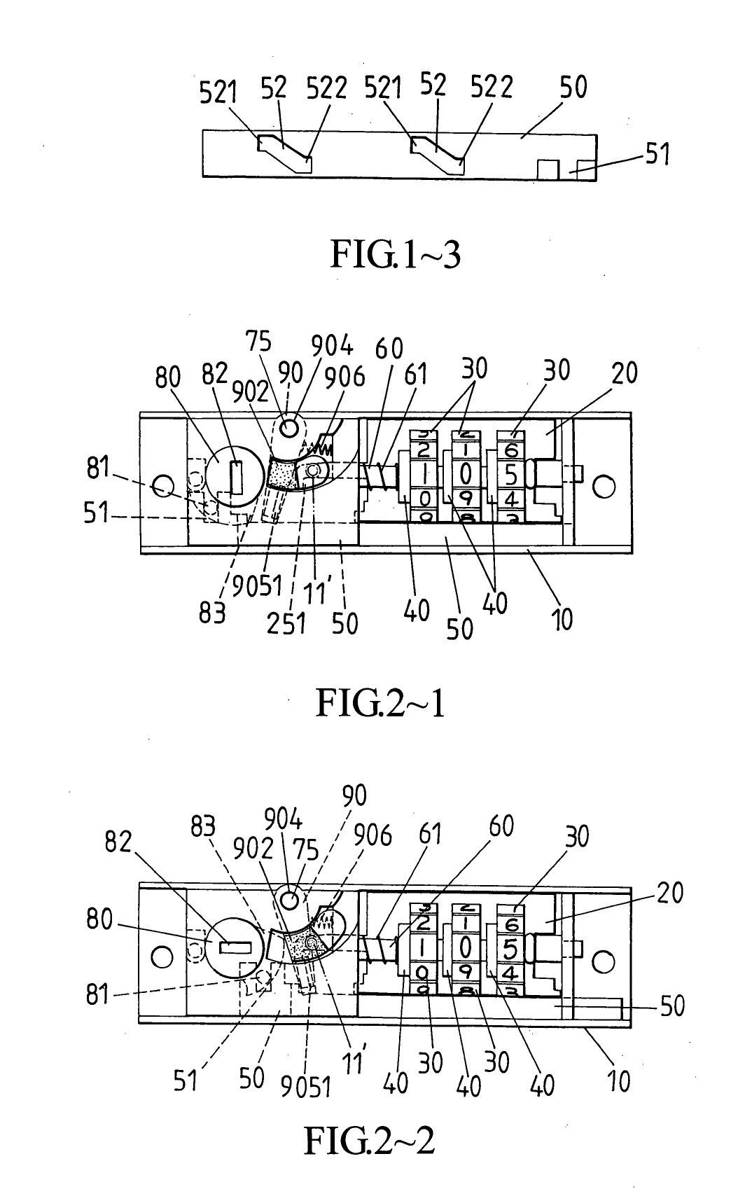

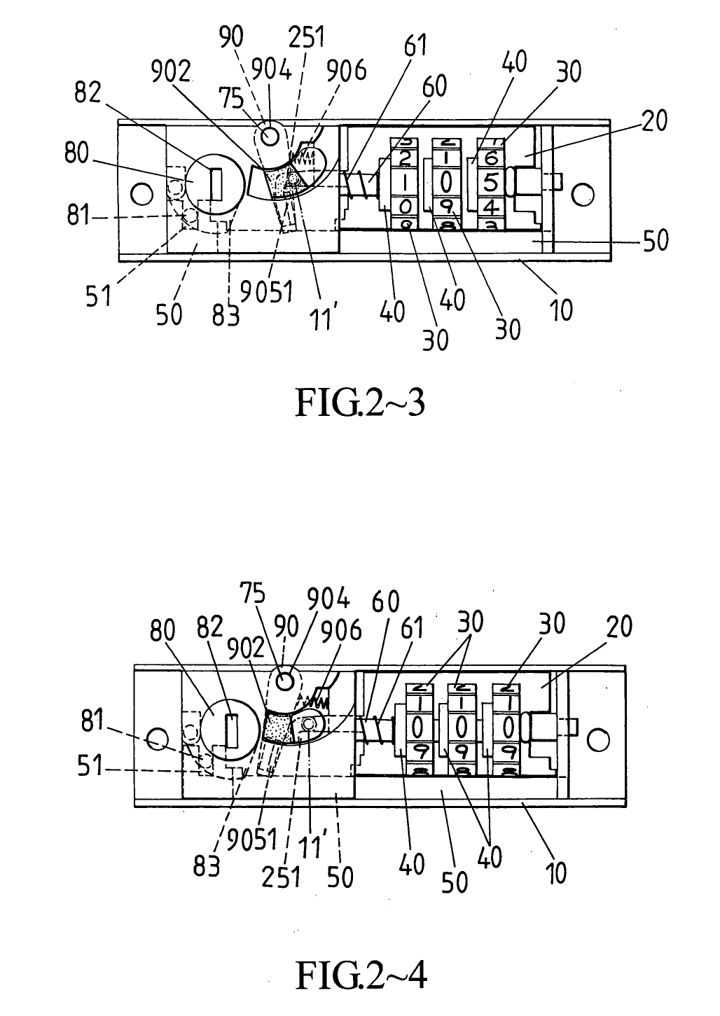

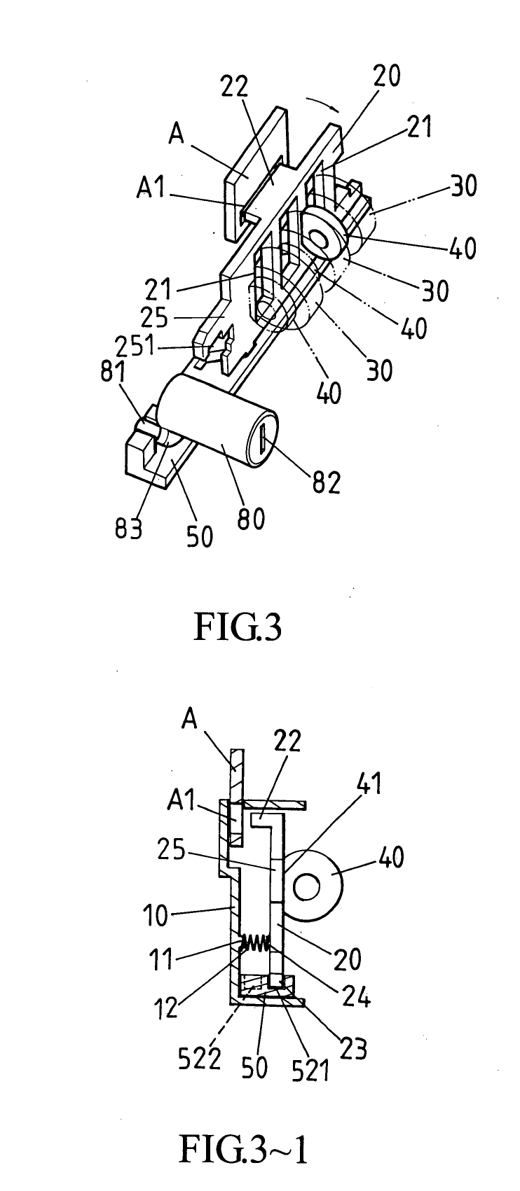

Referring to FIGS. 1 and 2, which shows the present invention comprising a housing 10, a swing plate 20, three dials 30, three sleeves 40, a slider 50, a shaft 60, an indicator seat 70 (also part of housing 10), a key tumbler 80 and an indicator member 90, wherein the swing plate 20 is movable relative to the housing 10. Three openings 21 are defined within the swing plate 20, and one end of the swing plate 20 is provided with a stopper 22 (as shown in FIG. 3) and another end is provided with tongues 23. An arm 25 having a recessed clasp notch 251 is located on a side of the swing plate 20 (as shown in FIG. 1˜2). The three dials 30 are respectively sleeve disposed with the sleeves 40, thereby enabling the shaft 60 to pass therethrough. A rim of each of the sleeves 40 is provided with a cutting 41 (as shown in FIG. 3˜1), and teeth provided on an inner side of each rim mesh with teeth of an inner ring of each of the dials 30 (not shown in the drawings). When the sleeves 40 and the dials 30 are clamp connected, a portion of each of the rims is exposed, and an inner side of each of the three dials 30 is disposed within the respective three openings 21 of the swing plate 20 (as shown in FIG. 3), thereby facilitating dialing of outer sides respectively protruding from an outer portion of the housing 10. A spring 61 is sleeve joined to one end of the shaft 60, and the tongues 23 located at a lower portion of the swing plate 20 (as shown in FIG. 1˜2) are used to clamp connect to the slider 50, one end of which is provided with a straight groove 51 to enable a push rod 81 of the key tumbler 80 to clamp therein. The key tumbler 80 is configured with a key hole 82 to enable a key to be inserted therein.

Referring to FIG. 1˜3, the slider 50 is configured with two sloping grooves 52, upper and lower ends of each of which are respectively provided with a transverse upper groove 521 and a lower groove 522.

Referring to FIG. 3˜1, a spring 12 is fixedly mounted between spring seats 11, 24 of the housing 10 and the swing plate 20 respectively.

The present invention is primarily characterized in that: the arm 25 is located on a side of the swing plate 20, and the clasp notch 251 is defined in a tail end of the arm 25 (as shown in FIG. 1˜2). The L-shaped indicator seat 70 is part of the housing 10, and a square-shaped through hole 71 of a side plate of the indicator seat 70 enables the arm 25 of the swing plate 20 to penetrate therethrough, while another circular-shaped shaft hole 72 enables the shaft 60 to penetrate and be disposed therein. A faceplate of the indicator seat 70 is provided with a lock hole 73 and an arc-shaped indicator hole 74, wherein the lock hole 73 enables the key tumbler 80 to penetrate therein, and the indicator hole 74 enables the indicator member 90 to be held therein. An inner side of the key tumbler 80 near an eccentric rod 81 is provided with an end cam 83 (as shown in FIG. 2˜1). The indicator member 90 is separated into a green indicator (first surface) 901 and a red indicator (second surface) 902. A front panel 10′ of the suitcase lock is provided with an indicator window 11′ that enables disclosing whether the indicator member 90 is the green indicator 901 or the red indicator 902. An inner side of the indicator member 90 is a raised member 903, a top portion of which is pin connected to a shaft 75 of the indicator seat 70 through a shaft hole 904. A frame slot 905 of an inner portion of the raised member 903 enables the arm 25 of the swing plate 20 penetrate therethrough. The frame slot 905 is provided with an elastic inverted hook 9051, and the inverted hook 9051 having a bevel face is able to fixedly hook within the clasp notch 251 of the arm 25. A spring 906 is installed on one end of the raised member 903, and another end of the spring 906 abuts against a side panel of the indicator seat 70.

The swing plate 20 of the suitcase lock of the present invention can be positioned at least three angles:

Referring to FIGS. 3 and 3˜1, which depict the first angle position of the swing plate 20, wherein when a combination of numbers on the dials 30 are such to place the lock in a locked state, the cutting 41 of each of the sleeves 40 is outwardly deviated from an edge of the swing plate 20, and the arm 25 is simultaneously outwardly displaced, while the indicator window 11′ of front panel 10′ discloses the green indicator 901 of the indicator member 90, and the inverted hook 9051 of the indicator member 90 has not yet hooked into the clasp notch 251 of the arm 25 of the swing plate 20.

Referring to FIGS. 2˜1, 4 and 4˜1, which depict the second angle position of the swing plate 20, wherein when a combination of numbers on the dials 30 are such to place the lock in a locked state (that is, the dials 30 have been rotated to a state that does not allow opening the lock), an inspector can insert a key into the key hole 82 of the key tumbler 80 to rotate the key tumbler 80 (as shown in FIGS. 2˜2, 5 and 5˜1), whereupon the cam 83 of the key tumbler 80 pushes the raised member 903 of the indicator member 90, thereby laterally deviating the raised member 903 about the shaft hole 904 of the indicator member 90 as center and simultaneously compressing the spring 906, which causes the indicator 70 to be displaced, and the green indicator 901 originally disclosed by the indicator window 11′ of the front panel 10′ is changed to the red indicator 902. At which time the bevel face and elasticity of the inverted hook 9051 of the indicator member 90 enables the inverted hook 9051 to be pushed into and be fixedly hooked within the clasp notch 251 of the arm 25, thereby preventing the spring 906 from restoring to its original position.

Referring to FIGS. 2˜2, 5 and 5˜1, which depict the third angle position of the swing plate 20, wherein when a combination of numbers on the dials 30 have placed the lock in a locked state, after inspected, an inspector can rotate and return the key tumbler 80 to its original position with the key, and the inverted hook 9051 of the indicator member 90 is still fixedly hooked within the clasp notch 251 of the arm 25, thus preventing the spring 906 from restoring to its original position, and the indicator window 11′ of the front panel 10′ still discloses the red indicator 902.

Referring to FIG. 2˜4, wherein when a combination of numbers on the dials 30 are such to enable opening the lock, the restoring force of the spring 12 drives the swing plate 20, thereby inwardly displacing to its first angle, and causing the clasp notch 251 of the arm 25 to separate from the inverted hook 9051 of the indicator member 90. The spring 906 then pushes the indicator member 90 about the shaft hole 904 as center to the position as shown in FIG. 2˜4, and the indicator member 90 is simultaneously displaced causing the red indicator 902 disclosed by indicator window 11′ of the front panel 10′ to restore to the green indicator 901.

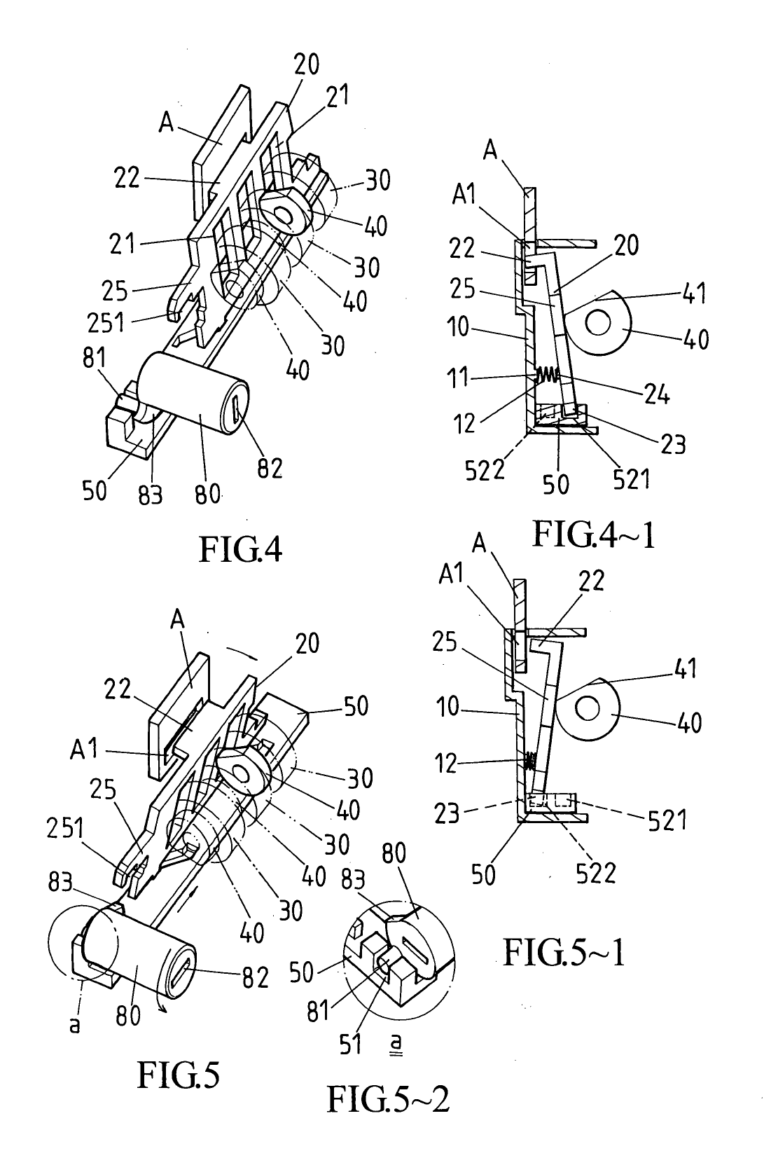

Referring to FIG. 3˜FIG. 5, which show the relationship between the slider 50, the swing plate 20 and the key tumbler 80, wherein a portion of the component members, such as the shaft 60, the dials 30, and so on, are not shown in the drawings.

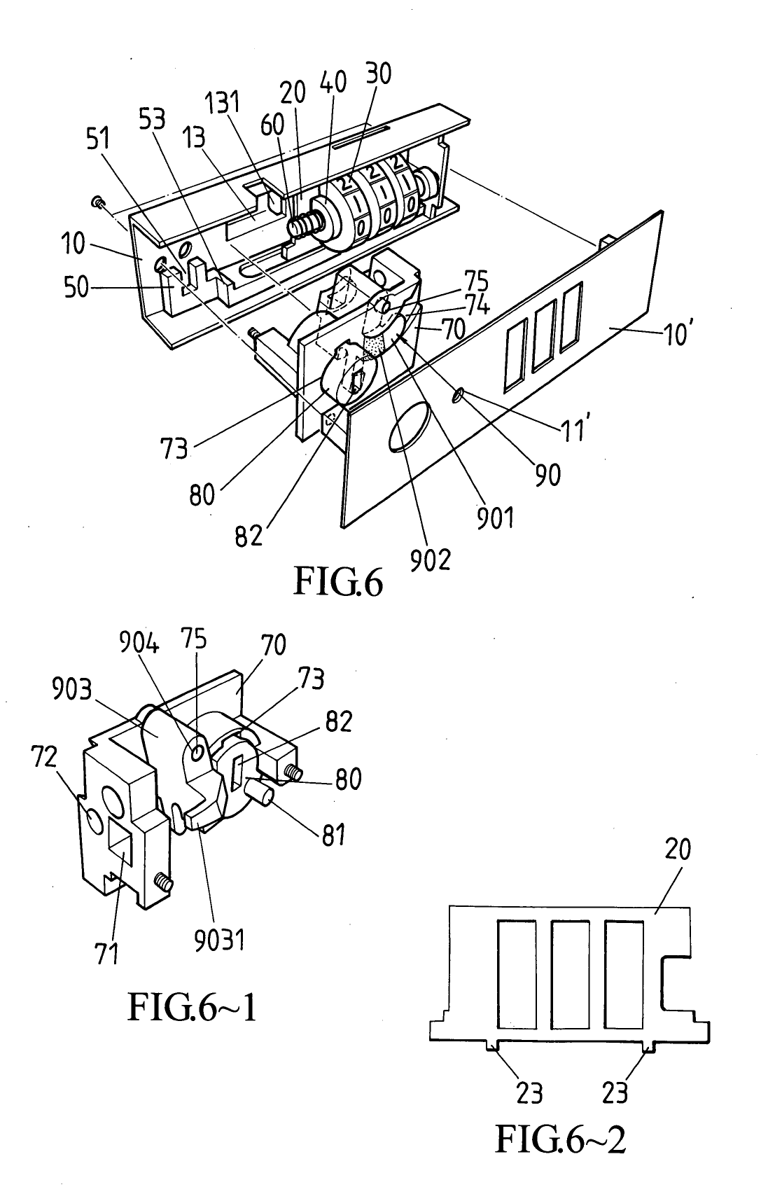

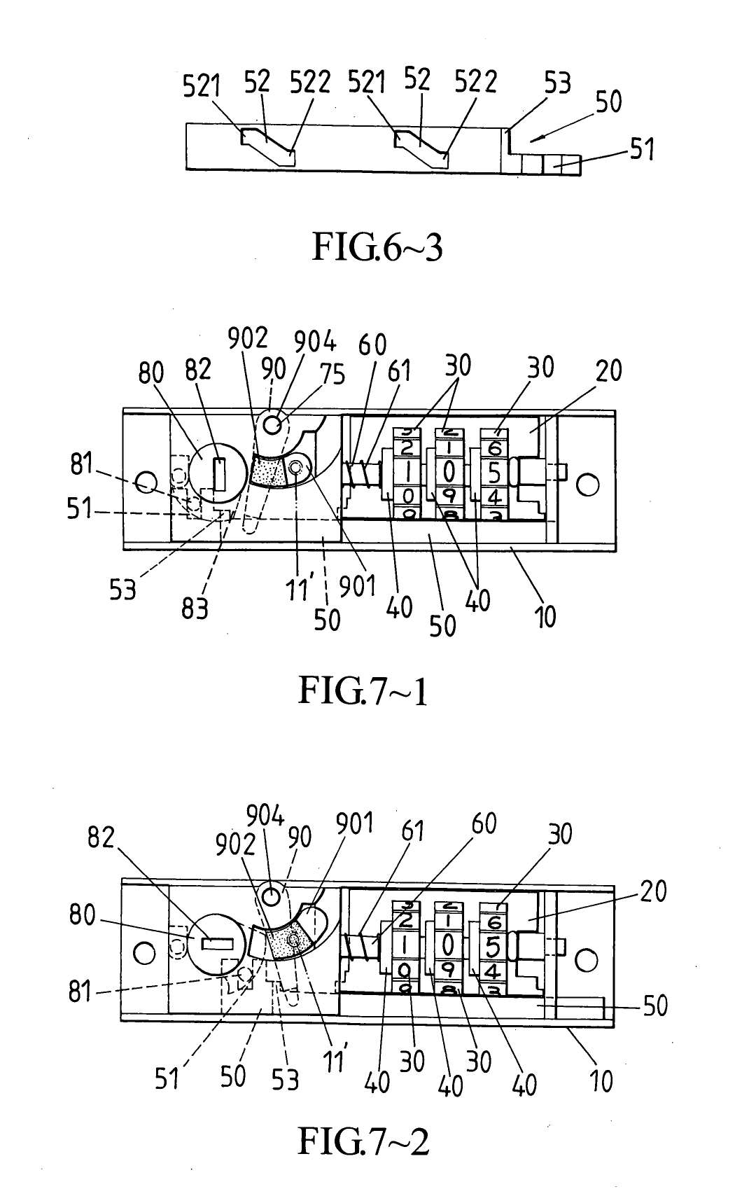

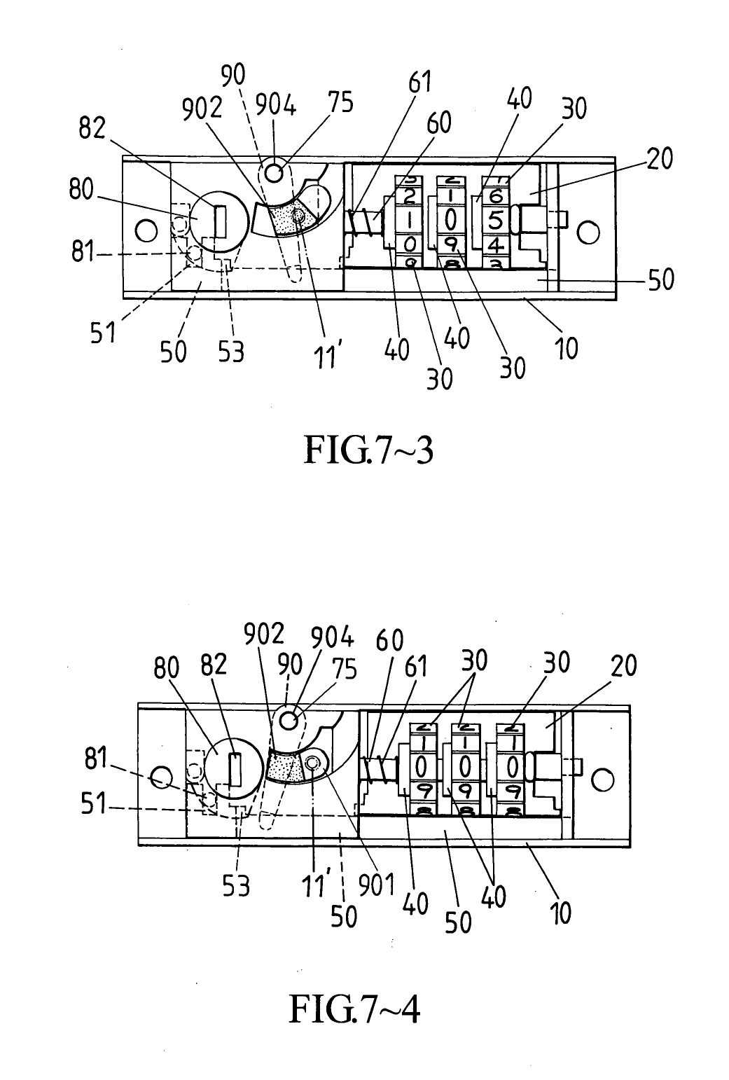

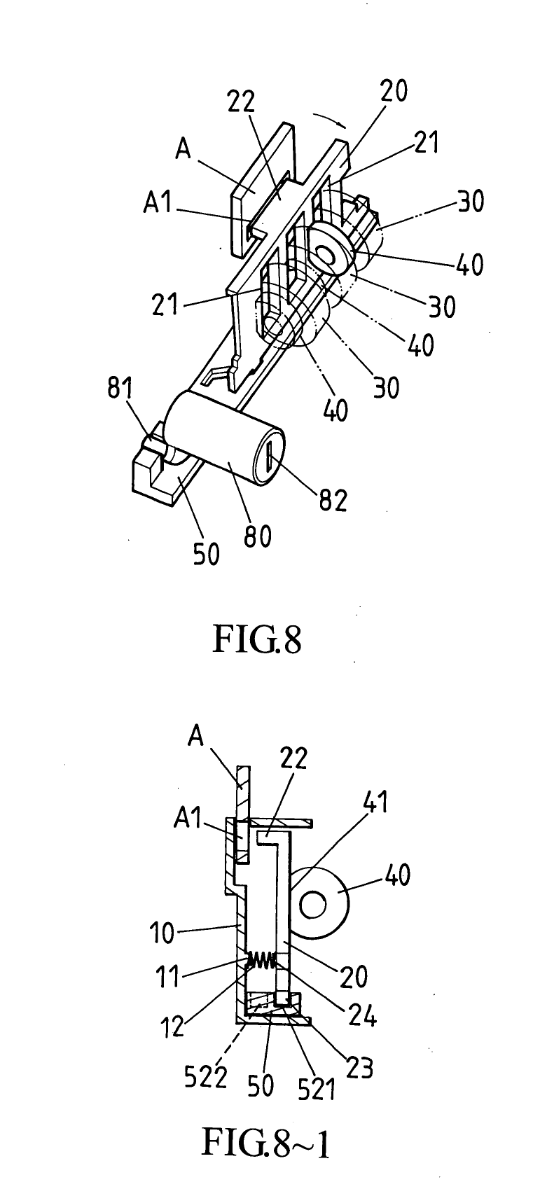

Referring to FIGS. 7˜1-FIGS. 7˜4, which show the present invention comprising the housing 10, the swing plate 20, the three dials 30, the three sleeves 40, the slider 50, the shaft 60, the indicator seat 70, the key tumbler 80 and the indicator member 90, wherein the swing plate 20 is movable relative to the housing 10. The three openings 21 are defined within the swing plate 20, and the end of the swing plate 20 is provided with the stopper 22 (as shown in FIG. 8) and the other end is provided with the tongues 23. The arm 25 having the recessed clasp notch 251 is located on the side of the swing plate 20 (as shown in FIG. 6˜2). The three dials 30 are respectively sleeve disposed with the sleeves 40, thereby enabling the shaft 60 to pass therethrough. The rim of each of the sleeves 40 is provided with the cutting 41 (as shown in FIG. 8˜1), and the teeth provided on the inner side of each rim mesh with the teeth of the inner ring of each of the dials 30 (not shown in the drawings). When the sleeves 40 and the dials 30 are clamp connected, a portion of each of the rims is exposed, and the inner side of each of the three dials 30 is disposed within the respective three openings 21 of the swing plate 20 (as shown in FIG. 8), thereby facilitating dialing of outer sides respectively protruding from the outer portion of the housing 10. The spring 61 is sleeve joined to the end of the shaft 60, and the tongues 23 located at the lower portion of the swing plate 20 (as shown in FIG. 6˜2) are used to clamp connect to the slider 50, the end of which is provided with the straight groove 51 to enable the push rod 81 of the key tumbler 80 to clamp therein, and the inner side of the straight groove 51 is configured with a raised member 53. The key tumbler 80 is configured with the key hole 82 to enable a key to be inserted therein.

Referring to FIG. 6˜3, the slider 50 is configured with the two sloping grooves 52, the upper and lower ends of each of which are respectively provided with the transverse upper groove 521 and the lower groove 522.

Referring to FIG. 8˜1, the spring 12 is fixedly mounted between the spring seats 11, 24 of the housing 10 and the swing plate 20 respectively.

The present invention is primarily characterized in that: The L-shaped indicator seat 70 is part of the housing 10, while the other circular-shaped shaft hole 72 enables the shaft 60 to penetrate and be disposed therein. The faceplate of the indicator 70 is provided with the lock hole 73 and the arc-shaped indicator hole 74, wherein the lock hole 73 enables the key tumbler 80 to penetrate therein, and the indicator hole 74 enables the indicator member 90 to be held therein. The indicator member 90 is separated into the green indicator (first surface) 901 and the red indicator (second surface) 902. The front panel 10′ of the suitcase lock is provided with the indicator window 11′ that enables disclosing whether the indicator member 90 is the green indicator 901 or the red indicator 902. The top portion of the indicator member 90 is pin connected to the shaft 75 of the indicator 70 through the shaft hole 904. An end of the indicator member 90 is provided with a raised member 9031, which is disposed within a protrusion slot 13 of a back side of the housing 10 to enable one end of the raised member 9031 to be exposed outside a notch 131 of the protrusion slot (as shown in FIG. 6).

The swing plate 20 of the suitcase lock of the present invention can be positioned at least three angles:

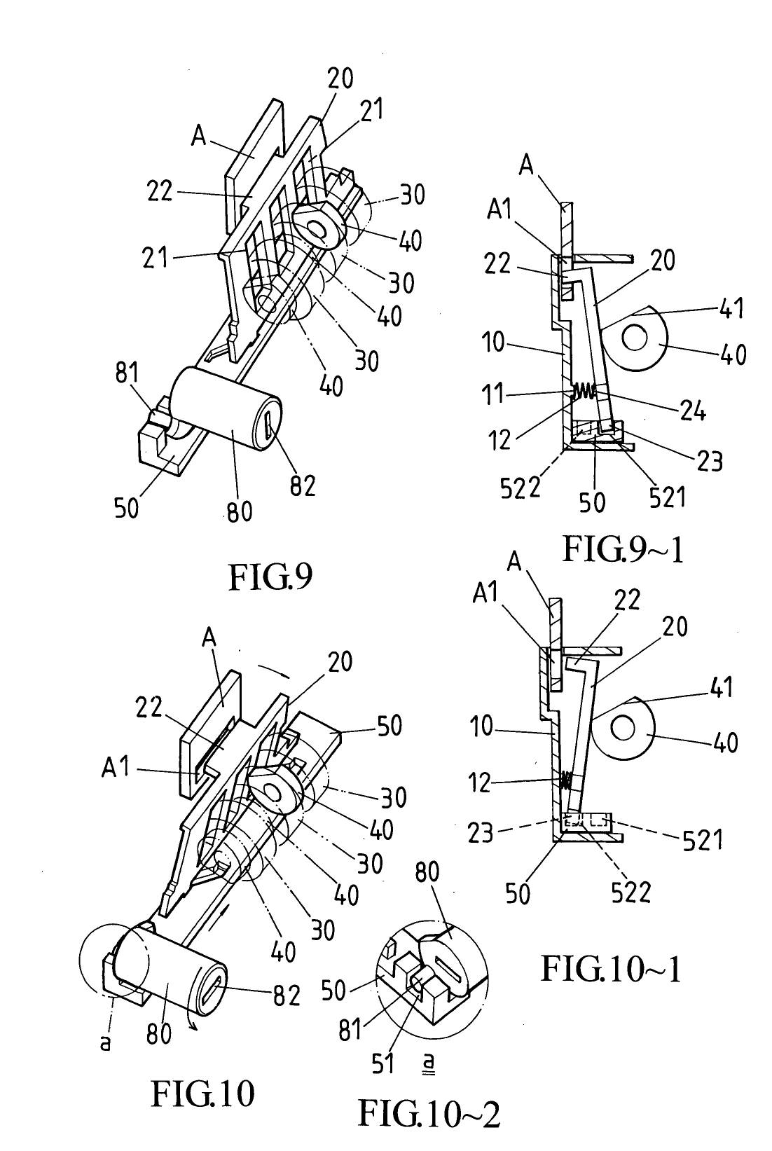

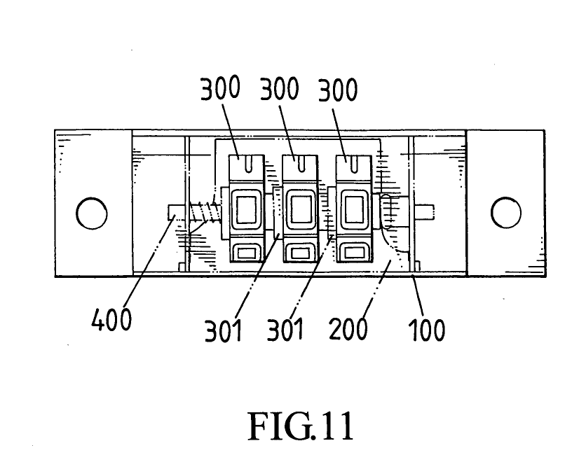

Referring to FIGS. 8 and 8˜1, which depict the first angle position of the swing plate 20, wherein when a combination of numbers on the dials 30 are such to place the lock in a locked state, the cutting 41 of each of the sleeves 40 is outwardly deviated from an edge of the swing plate 20, while the indicator window 11′ of the front panel 10′ discloses the green indicator 901 of the indicator member 90. Referring to FIGS. 7˜1, 9 and 9˜1, which depict the second angle position of the swing plate 20, wherein when a combination of numbers on the dials 30 are such to place the lock in a locked state (that is, the dials 30 have been rotated to a state that does not allow opening the lock), an inspector can insert a key into the key hole 82 of the key tumbler 80 to rotate the key tumbler 80 (the key hole 82 is now horizontal as FIGS. 10, 10˜1), whereupon the eccentric rod 81 of the key tumbler 80 drives and displaces the slider 50 in a rightward direction, and the raised member 53 of the slider 50 pushes the indicator member 90, thereby laterally deviating the shaft hole 904 of the indicator member 90 as center, which causes the indicator member 90 to be displaced, and the green indicator 901 originally disclosed by the indicator window 11′ of the front panel 10′ is now changed to the red indicator 902, at which time the raised member 9031 of the indicator member 90 is exposed outside the notch 131 of the housing 10. Referring to FIGS. 7˜2, 10 and 10˜1, which depict the third angle position of the swing plate 20, wherein when a combination of numbers on the dials 30 have placed the lock in a locked state, after inspected, an inspector can rotate and return the key tumbler 80 to its original position (as FIG. 7˜3) with the key (the key hole 82 is now vertical). Moreover, because the raised member 9031 of the indicator member 90 remains exposed outside, and has not yet returned to within the protrusion slot 13, thus, the indicator window 11′ of the front panel 10′ still discloses the red indicator 902.

Referring to FIG. 7˜4, wherein when a combination of numbers on the dials 30 are such to enable opening the lock, the restoring force of the spring 12 drives the swing plate 20 to first angle, allowing the owner can open the suitcase he/she now can manually press the raised member 9031 to return it to within the protrusion slot 13 of the housing 10, at which time the indicator member 90 is moved about the shaft 75 as center to the position as shown in FIG. 7˜1, and the indicator 70 is simultaneously displaced causing the red indicator 902 disclosed by indicator window 11′ of the front panel 10′ to change to the green indicator 901.

Referring to FIG. 8˜FIG. 10, which show the relationship between the slider 50, the swing plate 20 and the key tumbler 80, wherein a portion of the component members, such as the shaft 60, the dials 30, and so on, are not shown in the drawings.

As is apparent from the foregoing, apart from the suitcase lock of the present invention enabling the dials 30 of the housing 10 to open and close the lock, a key can also be used to rotate the key tumbler 80 to enable force opening of the lock when the dials 30 are in a locked position. The present invention also includes the indicator window 11′ in the housing 10, whereby when the key rotates the key tumbler 80, the indicator 70 is simultaneously caused to rotate, and different colors of first and second surfaces of the indicator member 90 are disclosed by the indicator window 11′. Hence, the indicator window 11′ enables viewing the different colors of the first and second surfaces, thereby disclosing the state of the suitcase lock at that time.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A suitcase lock with indicator that can be opened either by setting a combination or by a key, comprising a housing and a swing plate that is movable relative to the housing, wherein the swing plate is positioned at at least three angles;
a first angle position is realized by setting an unlock combination of numbers; a second angle is realized by setting a combination of numbers that does not allow opening the lock; a third angle is realized by a key;
the second angle and the third angle are in opposite directions, and both the first and third angle positions enable releasing a locked object;
moreover, the suitcase lock has an indicator for indicating whether the suitcase lock has been opened by a key, wherein the indicator includes an indicator member connected to the housing to enable movement between first and second positions; the indicator member displays a first surface that is viewable through a window of the housing when in the first position, and displays a second surface that is viewable through the window when in the second position; the first surface and the second surface differ in appearance from each other; when the key causes the swing plate to move to the third angle position, then the indicator member is simultaneously moved to the second position; and setting an unlock combination of numbers on dials moves the swing plate to the first angle position, and the indicator member can be moved to the first position.

2. The suitcase lock of claim 1, wherein the first and second surfaces are of different colors.

3. The suitcase lock of claim 1, wherein the first surface displays a green color, and the second surface displays a red color.

4. The suitcase lock of claim 1, wherein the indicator can only be reset from displaying the second surface to displaying the first surface by setting an unlock combination of numbers on the dials and opening the lock.

5. The suitcase lock of claim 1, wherein a small portion or no portion of the indicator member protrudes from the housing when in the first position.

6. The suitcase lock of claim 1, wherein a certain portion of the indicator member protrudes from the housing when in the second position.
